(19) United States
(12) Patent Application Publication
(10) Pub. No.: US 2026/0009421 A1
(43) Pub. Date: Jan. 8, 2026

(54) JAM NUT ASSEMBLY

(71) Applicant: Dash LLC, Murray, UT (US)

(72) Inventors: Daniel J. Steed, Murray, UT (US); Jeremy M. Fairbourne, Murray, UT (US); Shiloh D. Poulsen, Murray, UT (US)

(21) Appl. No.: 18/764,968

(22) Filed: Jul. 5, 2024

(51) Int. Cl. F16B 39/30; F16B 37/00

(52) U.S. Cl. CPC F16B 39/30; F16B 37/00

(57) ABSTRACT

A nut locking assembly is disclosed. The nut locking assembly includes a locking structure, a first nut, and a second nut. The first nut includes a first body, a first nut internal threading formed in the first body, and a first nut recessed portion formed in the first body. The first nut recessed portion receiving a first end of the locking structure therein. The second nut including a second body, a second nut internal threading formed in the second body, and a second nut recessed portion formed in the second body. The second nut recessed portion receiving a second end of the locking structure therein. The second nut internal threading substantially aligns with the first nut internal threading.

### TECHNICAL FIELD

The present disclosure generally relates to a nut locking assembly. More particularly, the present disclosure relates to a multi-nut locking assembly.

### BACKGROUND

Nuts used in a bolted joint may be required to be tightened to a particular torque/tension depending on a particular use for the nut. However, the nut may become loose and fail to hold tension with the bolt with the application of vibrational or other forces. Locking nuts are arranged to prevent vibrational and other forces applied thereto from loosening the tension of the bolted joint. However, securing the locking nut in the exact position with a desired tension may be difficult to achieve with precision.

The above-described background relating to locking nuts is merely intended to provide a contextual overview of some current issues and is not intended to be exhaustive. Other contextual information may become apparent to those of ordinary skill in the art upon review of the following description, which includes example embodiments.

### BRIEF SUMMARY

In one illustrative embodiment, the present disclosure provides a nut locking assembly. The nut locking assembly includes a locking structure, a first nut, and a second nut. The first nut comprises a first body, a first nut internal threading, and a first nut recessed portion. The first nut internal threading formed in the first body. The first nut recessed portion are formed in the first body. The first nut recessed portion with a first end of the locking structure received therein. The second nut comprises a second body, a second nut internal threading, and a second nut recessed portion. The second nut internal threading formed in the second body. The second nut recessed portion formed in the second body. The second nut recessed portion with a second end of the locking structure received therein. The second nut internal threading substantially aligned with the first nut internal threading.

In another illustrative embodiment, the present disclosure provides a method for installing a nut locking assembly. The method includes threading an entirety of a nut locking assembly onto a bolt. The nut locking assembly includes a locking structure, a first nut, and a second nut. The first nut comprises a first body, a first nut internal threading, and a first nut recessed portion. The first nut internal threading formed in the first body. The first nut recessed portion are formed in the first body. The first nut recessed portion with a first end of the locking structure received therein. The second nut comprises a second body, a second nut internal threading, and a second nut recessed portion. The second nut internal threading formed in the second body. The second nut recessed portion formed in the second body. The second nut recessed portion with a second end of the locking structure received therein. The second nut internal threading substantially aligned with the first nut internal threading. The method also includes positioning a wrench over the first nut and the second nut of the nut locking assembly simultaneously and turning the first nut and the second nut together to position the first nut in a desired position. The method further includes positioning the wrench, while the first nut is in the desired position, to only contact the second nut and turn the second nut to move the second nut towards the first nut and compress the locking structure therebetween.

In a further illustrative embodiment, the present disclosure provides a nut locking assembly. The nut locking assembly includes a locking structure, a first nut, and a second nut. The first nut including a first body with a first end of the locking structure received therein. A first nut internal threading is formed in the first body. The second nut including a second body with a second end of the locking structure received. A second nut internal threading is formed in the second body. The second nut internal threading is substantially aligned with the first nut internal threading to prevent separation of the locking structure from either of the first nut and the second nut while threading both the first nut and the second nut on a bolt.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 is a perspective view of various embodiments of a nut locking assembly of the present disclosure;

FIG. 2 is a top view of the nut locking assembly of FIG. 1;

FIG. 3 is a cross-sectional view of the nut locking assembly of FIG. 1 taken along the line III-III of FIG. 2;

FIG. 4 is a flowchart of a method for installing a nut locking assembly;

FIG. 5 is a cross-sectional view of the nut locking assembly being threaded onto a bolt; and

FIG. 6 is another cross-sectional view of the nut locking assembly being threaded onto a bolt.

### DETAILED DESCRIPTION

In various embodiments, a nut locking assembly is disclosed. As will be described in greater detail below, the nut locking assembly includes a first nut, a second nut, and a locking structure secured to and between the first nut and the second nut. The locking structure is configured to, upon relative axial movement between the first nut and the second nut, moves over, across, and/or between threads of the bolt and at least the first nut to secure at least the first nut in position on the bolt, which may retain a desired tension between the first nut and the bolt. The internal threading of the first nut and the second nut are substantially aligned to prevent or minimize relative axial movement between the first nut and the second nut while initially threading the nut locking assembly onto the bolt. In various embodiments, external features of the first nut and the second nut are aligned to allow simultaneous reception of the first nut and the second nut within a wrench (e.g., without requiring rotation of either of the first nut and the second nut, without limitation).

In the detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the description of various embodiments is not intended to limit the scope of the present disclosure, but is merely representative of various embodiments. While the various aspects of the embodiments may be presented in drawings, the drawings are not necessarily drawn to scale unless specifically indicated.

In the Brief Summary and in the Detailed Description, the claims, and in the accompanying drawings, reference is made to particular features (including method acts) of the present disclosure. It is to be understood that the disclosure includes all possible combinations of such particular features. For example, where a particular feature is disclosed in the context of a particular embodiment, or a particular claim, that feature can also be used, to the extent possible, in combination with and/or in the context of other particular aspects and embodiments described herein.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the terms “adapted,” “configured,” and “configuration” refers to a size, a shape, a material composition, a material distribution, orientation, and arrangement of at least one feature (e.g. one or more of at least one structure, at least one material, at least one region, at least one device) facilitating use of the at least one feature in a pre-determined way.

As used herein, the term “may” with respect to a material, structure, feature, function, or method act indicates that such is contemplated for use in implementation of an embodiment of the disclosure, and such term is used in preference to the more restrictive term “is” so as to avoid any implication that other compatible materials, structures, features, functions, and methods usable in combination therewith should or must be excluded.

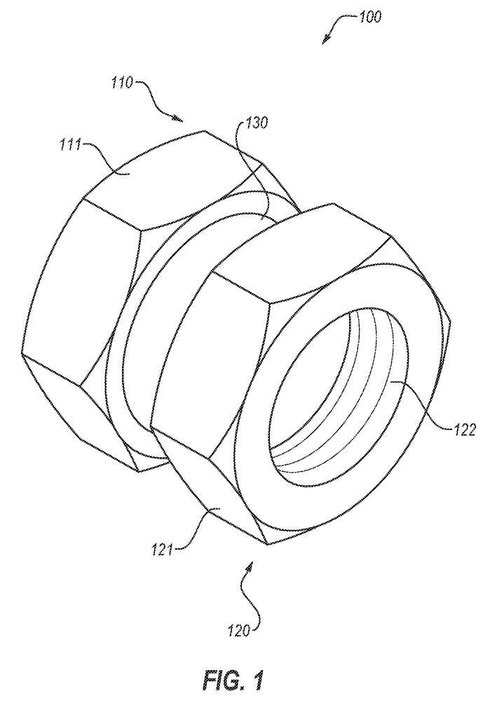

FIG. 1 is a perspective view of various embodiments of a nut locking assembly 100 of the present disclosure. Referring to FIG. 1, the nut locking assembly 100 a locking structure 130, a first nut 110, and a second nut 120. The locking structure 130 forms a middle structure of the nut locking assembly 100, interposed between and joining the first nut 110 and the second nut 120 together. In various embodiments, the locking structure 130 is formed of polymeric material, such as a polymer of synthetic polymer (e.g., nylon, without limitation). Other materials with similar properties (elasticity, resiliency, durability (e.g., resistance to chemical damage, without limitation) are also contemplated.

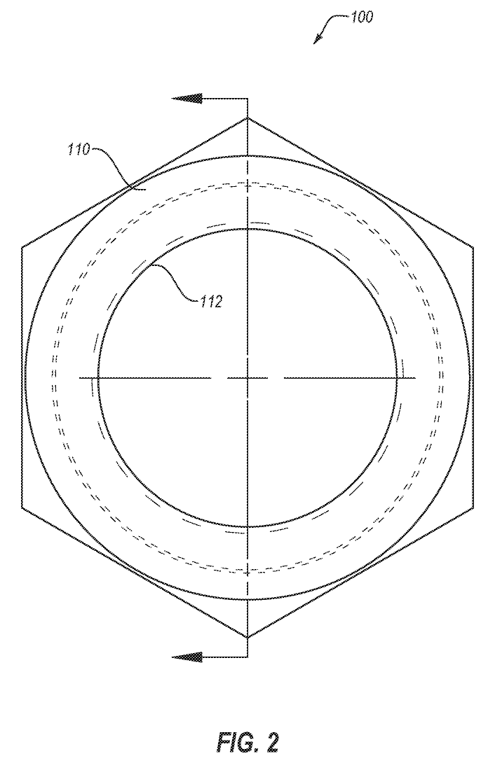

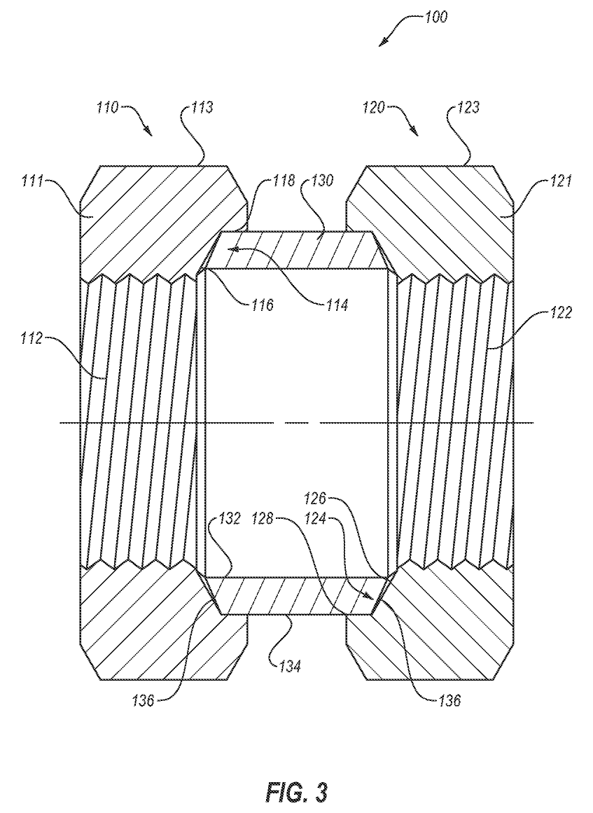

FIG. 2 is a side view of the nut locking assembly 100 of FIG. 1. FIG. 3 is a cross-sectional view of the nut locking assembly 100 of FIG. 1 taken along the line III-III of FIG. 2. Referring to FIGS. 1-3, the locking structure 130 includes a hollow cylinder shape (e.g., a hollow right circular cylinder, without limitation). The locking structure 130 includes a locking structure outer surface 134 and a locking structure inner surface 132 defining the hollow cylinder shape. The locking structure outer surface 134 and the locking structure inner surface 132 may each be a right circular cylindrical surface. In various embodiments, the locking structure 130 also includes a locking structure taper 136 at outer edges thereof. The locking structure taper 136 may be a chamfer between the locking structure outer surface 134 and ends of the locking structure 130.

The first nut 110 includes a first body 111 including a first nut internal threading 112, a first exterior shape 113, and a first nut recessed portion 114 formed therein. The first body 111 includes a first thickness measured between ends thereof. The first nut internal threading 112 extends between the ends of the first nut 110 and includes a major diameter (outside diameter), a minor diameter (inside diameter), a thread pitch, and a thread direction (e.g., right-handed thread direction or left-handed thread direction). In various embodiments, the major diameter of the first nut internal threading 112 is smaller than a diameter of at least a majority of a length of the locking structure inner surface 132 or of the diameter of the entirety of the locking structure inner surface 132. The first exterior shape 113 includes a first geometry (e.g., hexagonal shape, square shape, without limitation), configured for gripping the first nut 110 with a wrench (e.g., socket wrench, torque wrench, or spanner, without limitation).

The first nut recessed portion 114 extends into the first body 111 from one of the ends thereof and defines a recess configured to receive a first end portion of the locking structure 130. In various embodiments, the first end portion of the locking structure 130 is received in the first nut recessed portion 114 with a press fit (e.g., interference/friction fit, without limitation) for securing the locking structure 130 to the first nut 110. The first nut internal threading 112 may extend from the first nut recessed portion 114 to an opposing end of the first body 111.

In various embodiments, the first nut recessed portion 114 includes a first nut recess surface 118. The first nut recess surface 118 is radially inward facing and formed adjacent to an end of the first body 111. The first nut recess surface 118 includes a shape that is substantially similar to the shape of the locking structure outer surface 134. In various embodiments, the first nut recess surface 118 includes a cylindrical shape (e.g., a right circular cylindrical shape, without limitation).

The first nut recess surface 118 may be configured to be in an interference condition with the locking structure outer surface 134 and may include a diameter that is smaller than the diameter of the locking structure outer surface 134. Other forms of press fits (e.g., ribs and grooves, without limitation) are also contemplated. The press fit between the first nut 110 and the locking structure 130 is arranged to prevent relative movement (e.g., axial and circumferential movement, without limitation) therebetween unless an intentional torque or axial force is applied thereto (e.g., a torque applied to the first nut 110 or an axial force applied by turning one of the first nut 110 and the second nut 120, without limitation).

In various embodiments, the first nut recessed portion 114 also includes a first nut taper 116. The first nut taper 116 extends between the first nut recess surface 118 and the first nut internal threading 112. In some of these various embodiments, the first nut taper 116 includes a frusto-conical shape and is configured to receive a portion of the locking structure 130 therein. A locking structure taper 136 may contact the first nut taper 116 while the locking structure 130 is assembled with the first nut 110 and received within the first nut recessed portion 114. In some of these various embodiments, an angle of the first nut recess surface 118 and the locking structure taper 136 are substantially similar (e.g., substantially parallel, without limitation).

The second nut 120 includes a second body 121 including a second nut internal threading 122, a second exterior shape 123, and a second nut recessed portion 124 formed therein. The second body 121 includes a first thickness measured between ends thereof. The second nut internal threading 122 extends between the ends of the second nut 120 and includes a major diameter (outside diameter), a minor diameter (inside diameter), a thread pitch, and a thread direction (e.g., right-handed thread direction or left-handed thread direction). Each of the major diameter, minor diameter, thread pitch, and thread direction of the second nut internal threading 122 is the same or substantially the same as the major diameter, minor diameter, thread pitch, and thread direction of the first nut internal threading 112. In various embodiments, the major diameter of the second nut internal threading 122 is smaller than a diameter of at least a majority of a length of the locking structure inner surface 132 or of the diameter of the entirety of the locking structure inner surface 132. The second exterior shape 123 includes a second geometry (e.g., hexagonal shape, square shape, without limitation), configured for gripping the second nut 120 with a wrench (e.g., socket wrench, torque wrench, or spanner, without limitation). The second exterior shape 123 and the second geometry is the same or substantially the same as the first exterior shape 113 and the first geometry.

The second nut recessed portion 124 extends into the second body 121 from one of the ends thereof and defines a recess configured to receive a second end portion of the locking structure 130. In various embodiments, the second end portion of the locking structure 130 is received in the second nut recessed portion 124 with a press fit (e.g., interference/friction fit, without limitation) for securing the locking structure 130 to the second nut 120. The second nut internal threading 122 may extend from the second nut recessed portion 124 to an opposing end of the second body 121.

In various embodiments, the second nut recessed portion 124 includes a second nut recess surface 128. The second nut recess surface 128 is radially inward facing and formed adjacent to an end of the second body 121. The second nut recess surface 128 includes a shape that is substantially similar to the shape of the locking structure outer surface 134. In various embodiments, the second nut recess surface 128 includes a cylindrical shape (e.g., a right circular cylindrical shape, without limitation).

The second nut recess surface 128 may be configured to form an interference condition with the locking structure outer surface 134 and may include a diameter that is smaller than the diameter of the locking structure outer surface 134. Other forms of press fits (e.g., ribs and grooves, without limitation) are also contemplated. The press fit between the second nut 120 and the locking structure 130 is arranged to prevent relative movement (e.g., axial and circumferential movement, without limitation) therebetween unless an intentional torque or axial force is applied thereto (e.g., a torque applied to the second nut 120 or an axial force applied by turning one of the first nut 110 and the second nut 120, without limitation).

The second nut recess surface 128 may be the same or substantially similar to the first nut recess surface 118. The first nut recess surface 118 and the second nut recess surface 128 are configured to face one another while the first nut 110 and the second nut 120 are in an assembled state with the locking structure 130.

In various embodiments, the second nut recessed portion 124 also includes a second nut taper 126. The second nut taper 126 extends between the second nut recess surface 128 and the second nut internal threading 122. In some of these various embodiments, the second nut taper 126 includes a frusto-conical shape and is configured to receive a portion of the locking structure 130 therein. A locking structure taper 136 may contact the second nut taper 126 while the locking structure 130 is assembled with the second nut 120 and received within the second nut recessed portion 124. In some of these various embodiments, an angle of the second nut recess surface 128 and the locking structure taper 136 are substantially similar (e.g., substantially parallel, without limitation).

In an assembled state, the nut locking assembly 100 forms a one-piece unit before being placed on a bolt. In the assembled state, the first nut recessed portion 114 and the second nut recessed portion 124 face towards one another, the thread direction of each of the first nut internal threading 112 and the second nut internal threading 122 match, and the first nut internal threading 112 and the second nut internal threading 122 are substantially aligned to prevent separation of the locking structure 130 from either of the first nut 110 and the second nut 120 and to prevent substantial compression of the locking structure 130 between the first nut 110 and the second nut 120 while threading both the first nut and the second nut on a bolt. Substantial compression is where the locking structure 130 begins to be compressed over and/or across either of the first nut internal threading 112 or the second nut internal threading 122 or compressed into the void between the threading of the bolt and either of the first nut internal threading 112 or the second nut internal threading 122.

In various embodiments, the first nut internal threading 112 and the second nut internal threading 122 are substantially aligned by aligning an end of the first nut internal threading 112 (e.g., an ending thread of the first nut 110 adjacent to the first nut recessed portion 114), considering a length of the locking structure 130, align with a beginning of the second nut internal threading 122 (e.g., a beginning thread of the second nut 120 adjacent to the second nut recessed portion 124). This alignment while the first nut 110 and the second nut 120 are secured to the locking structure 130 may allow the exterior flats of the first nut 110 and the second nut 120 to align.

In various embodiments, in the assembled state, the first exterior shape 113 and the second exterior shape 123 are substantially aligned rotationally (e.g., geometric features, such as faces and corners of a hexagonal shape, are aligned in a circumferential direction relative to an axis of the nut locking assembly 100). The alignment of the first exterior shape 113 and the second exterior shape 123 allow both the first nut 110 and the second nut 120 to be received within a wrench without rotation of either the first nut 110 or the second nut 120.

In various embodiments, the first nut 110 and the second nut 120 are symmetrical other than the first nut internal threading 112 and the second nut internal threading 122, which include a same thread direction.

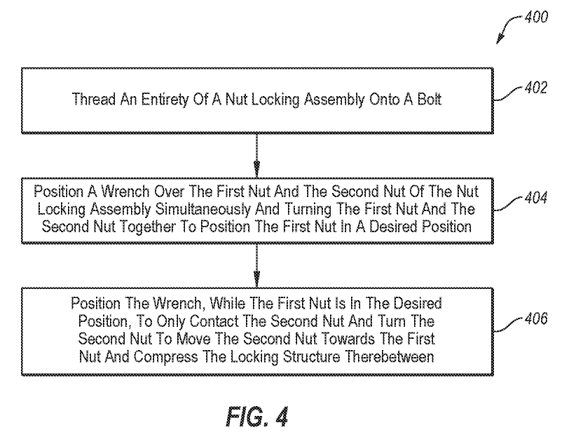

FIG. 4 is a flowchart of a method 400 for installing a nut locking assembly. The method 400 includes threading an entirety of a nut locking assembly onto a bolt at act 402. The nut locking assembly may be any embodiment of the nut locking assembly 100 described above. Threading the entirety of the nut locking assembly includes threading both the first nut and the second nut onto the bolt. The method 400 also includes positioning a wrench over the first nut and the second nut of the nut locking assembly simultaneously and turning the first nut and the second nut together to position the first nut in a desired position at act 404.

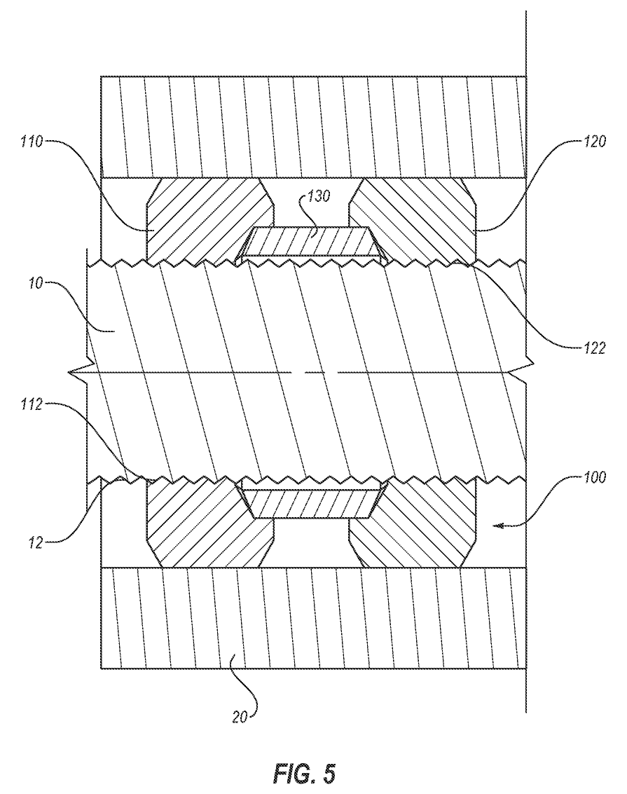

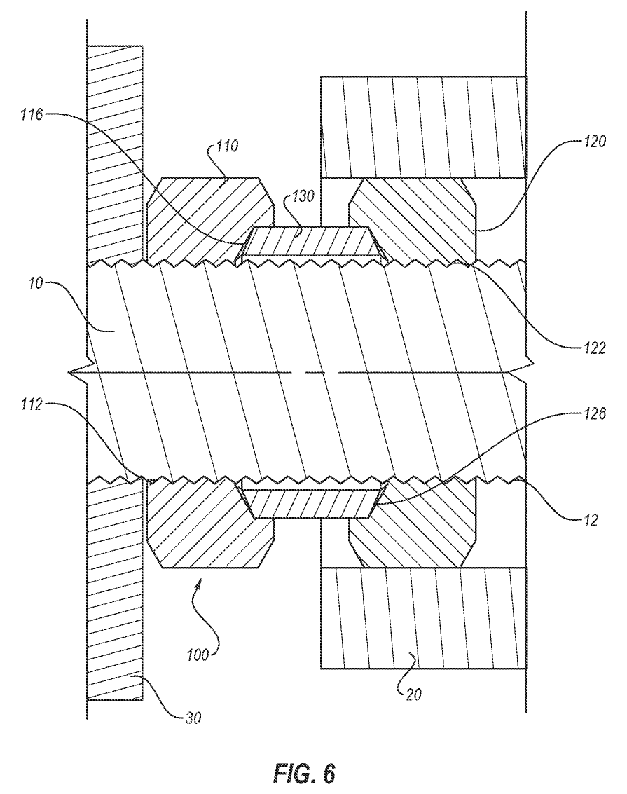

FIG. 5 is a cross-sectional view of the nut locking assembly 100 being threaded onto a bolt 10. FIG. 6 is another cross-sectional view of the nut locking assembly 100 being threaded onto a bolt 10. Referring to FIGS. 5 and 6, the wrench 20 (e.g., socket wrench, torque wrench, or spanner, without limitation) is positioned over the first nut 110 and the second nut 120 and rotated to move both the first nut 110 and the second nut 120, which may prevent separation of the first nut 110 and the second nut 120 from the locking structure 130 and may prevent compression of the locking structure 130 between the first nut 110 and the second nut 120 until the first nut 110 is in the desired position. The desired position may be adjacent to (e.g., abutting, without limitation) a component 30 (e.g., an object being fastened or a washer adjoining the object being fastened, without limitation). The desired position may also be where the first nut 110 has a desired tension or predetermined tension applied to the bolt 10.

Acts 402 and 404 may be performed simultaneously. For example, the entirety of the nut locking assembly may be received in the wrench prior to initiating the threading of the first nut and the second nut onto the bolt.

The method 400 includes positioning the wrench, while the first nut is in the desired position, to only contact the second nut and turn the second nut to move the second nut towards the first nut and compress the locking structure therebetween at act 406. As a result of act 406, the locking structure is compressed and crushed between the first nut and the second nut causing material thereof to move between the external threading (e.g., external threading 12) and the internal threading (e.g., first nut internal threading 112 or second nut internal threading 122) of the first nut, the second nut, or both the first nut and the second nut. Referring to FIG. 6, in various embodiments, the first nut taper 116 and the second nut taper 126 is angled to direct the material of locking structure 130 between the external threading 12 and the first nut internal threading 112 and the second nut internal threading 122 respectively.

By positioning both the first nut and the second nut simultaneously and subsequently engaging the second nut to compress and crush the locking structure to perform a locking function, there may not be a tension release of the first nut while preforming the locking function, and thus, the first nut may keep the desired tension during and after the locking function is performed. While the method 400 is disclosed with regards to positioning the first nut with the desired tension and moving the second nut relative to the first nut to lock the first nut in the desired position, in various embodiments, the second nut is positioned with the desired tension and the first nut is moved relative to the second nut to lock the second nut in the desired position and at the desired tension.

### Non-limiting example embodiments of the present disclosure may include:

Embodiment 1: A nut locking assembly comprising: a locking structure; a first nut comprising a first body, a first nut internal threading formed in the first body, and a first nut recessed portion formed in the first body, the first nut recessed portion with a first end of the locking structure received therein; and a second nut comprising a second body, a second nut internal threading formed in the second body, and a second nut recessed portion formed in the second body, the second nut recessed portion with a second end of the locking structure received therein and the second nut internal threading substantially aligned with the first nut internal threading.

Embodiment 2: The nut locking assembly according to Embodiment 1, wherein the first nut internal threading and the second nut internal threading are substantially aligned to prevent separation of the locking structure from either of the first nut and the second nut and to prevent substantial compression of the locking structure between the first nut and the second nut while threading both the first nut and the second nut on a bolt.

Embodiment 3: The nut locking assembly according to any of Embodiments 1 and 2, wherein substantial compression includes the locking structure beginning to be compressed into either the first nut internal threading or the second nut internal threading.

Embodiment 4: The nut locking assembly according to any of Embodiments 1 through 3, wherein the first nut includes a first exterior shape and the second nut includes a second exterior shape substantially similar to the first exterior shape, and wherein the first exterior shape and the second exterior shape are substantially aligned rotationally.

Embodiment 5: The nut locking assembly according to any of Embodiments 1 through 4, wherein each of the first exterior shape and the second exterior shape include a hexagonal shape and faces and corners thereof are aligned in a circumferential direction.

Embodiment 6: The nut locking assembly according to any of Embodiments 1 through 5, wherein the locking structure includes an inner surface, and wherein a major diameter of each of the first nut internal threading and the second nut internal threading is smaller than a diameter of at least a majority of a length of the inner surface of the locking structure.

Embodiment 7: The nut locking assembly according to any of Embodiments 1 through 6, wherein the major diameter of each of the first nut internal threading and the second nut internal threading is smaller than an entirety of the inner surface of the locking structure.

Embodiment 8: The nut locking assembly according to any of Embodiments 1 through 7, wherein the locking structure includes an outer surface, the first nut recessed portion includes a first nut recessed surface facing radially inward, and the second nut recessed portion includes a second nut recessed surface facing radially inward, and wherein each of the first nut recessed surface and the second nut recessed surface includes a diameter smaller than a diameter than the outer surface of the locking structure and in an interference condition therewith.

Embodiment 9: A method for installing a nut locking assembly, the method comprising: threading an entirety of a nut locking assembly onto a bolt, the nut locking assembly comprising: a locking structure; a first nut comprising a first body, a first nut internal threading formed in the first body, and a first nut recessed portion formed in the first body, the first nut recessed portion with a first end of the locking structure received therein; and a second nut comprising a second body, a second nut internal threading formed in the second body, and a second nut recessed portion formed in the second body, the second nut recessed portion with a second end of the locking structure received therein and the second nut internal threading substantially aligned with the first nut internal threading; positioning a wrench over the first nut and the second nut of the nut locking assembly simultaneously and turning the first nut and the second nut together to position the first nut in a desired position; and positioning the wrench, while the first nut is in the desired position, to only contact the second nut and turn the second nut to move the second nut towards the first nut and compress the locking structure therebetween.

Embodiment 10: The method according to Embodiment 9, wherein the desired position is adjacent to a component being fastened.

Embodiment 11: The method according to any of Embodiments 9 and 10, wherein the desired position includes the first nut having a desired tension or a predetermined tension applied to the bolt.

Embodiment 12: The method according to any of Embodiments 9 through 11, wherein the first nut internal threading and the second nut internal threading are substantially aligned to prevent separation of the locking structure from either of the first nut and the second nut and to prevent substantial compression of the locking structure between the first nut and the second nut while threading both the first nut and the second nut on a bolt.

Embodiment 13: The method according to any of Embodiments 9 through 12, wherein substantial compression includes the locking structure beginning to be compressed into either the first nut internal threading or the second nut internal threading.

Embodiment 14: A nut locking assembly comprising: a locking structure; a first nut comprising a first body with a first end of the locking structure received therein, a first nut internal threading formed in the first body; and a second nut comprising a second body with a second end of the locking structure received, a second nut internal threading formed in the second body, the second nut internal threading substantially aligned with the first nut internal threading to prevent separation of the locking structure from either of the first nut and the second nut while threading both the first nut and the second nut on a bolt.

Embodiment 15: The nut locking assembly according to Embodiment 14, wherein the second nut internal threading being substantially aligned with the first nut internal threading prevents substantial compression of the locking structure between the first nut and the second nut while threading both the first nut and the second nut on a bolt, substantial compression includes the locking structure beginning to be compressed into either the first nut internal threading or the second nut internal threading.

Embodiment 16: The nut locking assembly according to any of Embodiments 14 and 15, wherein the first nut includes a first exterior shape and the second nut includes a second exterior shape substantially similar to the first exterior shape, and wherein the first exterior shape and the second exterior shape are substantially aligned rotationally.

Embodiment 17: The nut locking assembly according to any of Embodiments 14 through 16, wherein each of the first exterior shape and the second exterior shape include a hexagonal shape and faces and corners thereof are aligned in a circumferential direction.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A nut locking assembly comprising:
a locking structure;
a first nut comprising a first body, a first nut internal threading formed in the first body, and a first nut recessed portion formed in the first body, the first nut recessed portion with a first end of the locking structure received therein; and
a second nut comprising a second body, a second nut internal threading formed in the second body, and a second nut recessed portion formed in the second body, the second nut recessed portion with a second end of the locking structure received therein and the second nut internal threading substantially aligned with the first nut internal threading.

2. The nut locking assembly of claim 1, wherein the first nut internal threading and the second nut internal threading are substantially aligned to prevent separation of the locking structure from either of the first nut and the second nut and to prevent substantial compression of the locking structure between the first nut and the second nut while threading both the first nut and the second nut on a bolt.

3. The nut locking assembly of claim 2, wherein substantial compression includes the locking structure beginning to be compressed into either the first nut internal threading or the second nut internal threading.

4. The nut locking assembly of claim 1, wherein the first nut includes a first exterior shape and the second nut includes a second exterior shape substantially similar to the first exterior shape, and wherein the first exterior shape and the second exterior shape are substantially aligned rotationally.

5. The nut locking assembly of claim 4, wherein each of the first exterior shape and the second exterior shape include a hexagonal shape and faces and corners thereof are aligned in a circumferential direction.

6. The nut locking assembly of claim 1, wherein the locking structure includes an inner surface, and wherein a major diameter of each of the first nut internal threading and the second nut internal threading is smaller than a diameter of at least a majority of a length of the inner surface of the locking structure.

7. The nut locking assembly of claim 6, wherein the major diameter of each of the first nut internal threading and the second nut internal threading is smaller than an entirety of the inner surface of the locking structure.

8. The nut locking assembly of claim 1, wherein the locking structure includes an outer surface, the first nut recessed portion includes a first nut recessed surface facing radially inward, and the second nut recessed portion includes a second nut recessed surface facing radially inward, and wherein each of the first nut recessed surface and the second nut recessed surface includes a diameter smaller than a diameter than the outer surface of the locking structure and in an interference condition therewith.

9. A method for installing a nut locking assembly, the method comprising:
threading an entirety of a nut locking assembly onto a bolt, the nut locking assembly comprising:
a locking structure;
a first nut comprising a first body, a first nut internal threading formed in the first body, and a first nut recessed portion formed in the first body, the first nut recessed portion with a first end of the locking structure received therein; and
a second nut comprising a second body, a second nut internal threading formed in the second body, and a second nut recessed portion formed in the second body, the second nut recessed portion with a second end of the locking structure received therein and the second nut internal threading substantially aligned with the first nut internal threading;
positioning a wrench over the first nut and the second nut of the nut locking assembly simultaneously and turning the first nut and the second nut together to position the first nut in a desired position; and
positioning the wrench, while the first nut is in the desired position, to only contact the second nut and turn the second nut to move the second nut towards the first nut and compress the locking structure therebetween.

10. The method of claim 9, wherein the desired position is adjacent to a component being fastened.

11. The method of claim 9, wherein the desired position includes the first nut having a desired tension or a predetermined tension applied to the bolt.

12. The method of claim 9, wherein the first nut internal threading and the second nut internal threading are substantially aligned to prevent separation of the locking structure from either of the first nut and the second nut and to prevent substantial compression of the locking structure between the first nut and the second nut while threading both the first nut and the second nut on a bolt.

13. The method of claim 12, wherein substantial compression includes the locking structure beginning to be compressed into either the first nut internal threading or the second nut internal threading.

14. A nut locking assembly comprising:
a locking structure;
a first nut comprising a first body with a first end of the locking structure received therein, a first nut internal threading formed in the first body; and
a second nut comprising a second body with a second end of the locking structure received, a second nut internal threading formed in the second body, the second nut internal threading substantially aligned with the first nut internal threading to prevent separation of the locking structure from either of the first nut and the second nut while threading both the first nut and the second nut on a bolt.

15. The nut locking assembly of claim 14, wherein the second nut internal threading being substantially aligned with the first nut internal threading prevents substantial compression of the locking structure between the first nut and the second nut while threading both the first nut and the second nut on a bolt, substantial compression includes the locking structure beginning to be compressed into either the first nut internal threading or the second nut internal threading.

16. The nut locking assembly of claim 14, wherein the first nut includes a first exterior shape and the second nut includes a second exterior shape substantially similar to the first exterior shape, and wherein the first exterior shape and the second exterior shape are substantially aligned rotationally.

17. The nut locking assembly of claim 16, wherein each of the first exterior shape and the second exterior shape include a hexagonal shape and faces and corners thereof are aligned in a circumferential direction.
